(19) United States
(12) Patent Application Publication
(10) Pub. No.: US 2010/0278974 A1
(43) Pub. Date: Nov. 4, 2010

(54) Methods for the Preparation of Vegetable Chips or French Fries

(75) Inventor: Marcus Wilhelmus Johannes Van Hulst, Muiderberg (NL)

Correspondence Address: THE WEBB LAW FIRM, P.C., 700 KOPPERS BUILDING, 436 SEVENTH AVENUE, PITTSBURGH, PA, 15219, US

(73) Assignee: BIMAJA HOLDING B.V., Muiderberg (NL)

(21) Appl. No.: 12/668,109

(22) PCT Filed: Jul. 9, 2008
(86) PCT No.: PCT/EP2008/005676

§ 371 Date: Jun. 9, 2010

(30) Foreign Application Priority Data
Jul. 9, 2007 (NL) 1034115

(51) Int. Cl. A23L 1/212; A23L 1/05; A23L 1/0522; A23P 1/10; A23J 1/02; A23L 1/28

(52) U.S. Cl. 426/61; 426/573; 426/578; 426/242; 426/541; 426/574

(57) ABSTRACT

A method for the preparation of vegetable chips or French fries is disclosed, wherein the method comprises: (i) preparing a mixture comprising between 20% to 90% (w/w) of a vegetable source and/or fruit source, a protein source, between 0% to 30% (w/w) water and a thickening agent; and (ii) moulding the mixture prepared into chips or French fries wherein none of said vegetable, fruit and protein sources comprise potato and, preferably, wherein the vegetable source is chosen from the group consisting of maize, carrot, pea, broccoli, cauliflower, bean, green bean, haricot bean, leek, onion, beet, rutabaga, and combinations thereof.

The present invention relates to methods for the preparation of vegetable chips or French fries. The present invention further relates to the vegetable chips or French fries obtained with the present methods.

In the last decades, overweight or obesitas has become an ever larger problem, and particularly in the developed countries. This because the increased number of obesitas cases is correlated with an increasing incidence of cardiovascular diseases and diabetes.

An additional problem is that particularly the number of juveniles with obesitas is increasing. This increase in the number of juveniles with obesitas can at least partially be explained by a change in the food consumption pattern.

In the past, generally three meals per day were consumed. Presently, this has changed. Especially juveniles show a consumption pattern which can be described as “snacking” or “grazing”. Because of this, the energy or caloric intake is relatively large. Further, as compared to the past, juveniles are also less mobile which also attributes to the development of obesitas.

Because of the altered consumption pattern of particularly juveniles, the consumption of fresh fruits and vegetables is also decreased. Considering the generally known positive effects of fruits and vegetables on health in general, and particularly obesitas, it is desirably to increase the consumption thereof.

Accordingly, it is an object of the present invention, amongst others, to provide at least a partial solution for the above problems, and particularly obesitas.

According to the present invention, amongst others, the above object is met by a method as defined in the appended claim 1.

Specifically, the present invention relates to a method for the preparation of vegetable chips or French fries, comprising:
i) preparing a mixture comprising between 20 to 90% (w/w) of a vegetable source and/or fruit source, a protein source, between 0 to 30%, preferably 3 to 30% (w/w) water and a thickening agent;
ii) moulding the mixture prepared into chips or French fries;
   wherein, preferably, the vegetable source is chosen from the group consisting of maize, carrot, pea, broccoli, cauliflower, bean, green bean, haricot bean, leek, onion, beet, rutabaga, and combinations thereof, and wherein none of said vegetable, fruit and protein sources comprise potato.

According to the present invention, the terms “chips” and “French fries” are used interchangeably.

According to the present invention, the present chips or French fries have preferably a substantially elongated columnar shape, although other shapes are also possible.

According to the present invention, the vegetable source does not comprise whole potato, potato parts or flour of potato (purée). This because, besides being a source of high calories, the use of potato does not provide a desirable texture and/or taste to the final product.

The method according to the present invention provides chips or French fries with a low caloric value and, additionally, provides a considerable amount of the recommended daily intake of vegetables and/or fruits. Because of this, not only the daily caloric intake is potentially reduced but also the general health is increased.

Preferably, the chips or French fries according to the present invention only comprise a vegetable source since this provides an improved texture of the final product.

The vegetable and/or fruit source according to the present invention can comprise vegetable and/or fruit parts but can also be processed, for example into a flour of leguminous vegetables and/or fruits, preferably vegetables.

According to the present invention, the protein source attributes to the texture of the final product. Additionally, the present protein source provides an improved browning of the final product when heated.

Preferably, the chips or French fries are, after step (ii), frozen to obtain, amongst others, a product with an extended shell-life.

Before step (ii), the vegetable and/or fruit source, preferably the vegetable source, is preheated, preferably preboiled. Heating, amongst others, inhibits or inactivates the enzyme activity present thereby improving the quality of the final product. Additionally, heating inhibits, or kills, optionally present pathogens.

In order to provide an optimal taste at a low caloric intake, the vegetable source comprises 50% to 60% (w/w), preferably 60% (w/w), of the present mixture.

Preferably, the present protein source comprises 2% to 30% (w/w), preferably 4 to 15% (w/w), of said mixture.

According to a preferred aspect of the present invention, the protein source is chosen from the group consisting of meat protein, blood protein, egg protein, whole egg, bean, and combinations thereof.

Also the thickening agent according to the present invention contributes to the texture of the final product.

Preferably, the thickening agent comprises a heat-binder and/or cold-binder, more preferably a heat-binder and a cold-binder.

A heat-binder provides the major binding activity at elevated temperatures such as cooking, baking and frying and a cold-binder provides the major binding activity at lower temperatures such as around ambient temperature.

Through the combined binding activities of the heat- and cold-binder, the texture of the final product in the temperature range of use, i.e., from below 0° C. to about 250° C., is maintained.

Preferably, the heat- and/or cold-binder comprise starch, modified starch or gum.

The binder (heat or cold) according to the present invention can also comprise alginic acid, sodium alginate, potassium alginate, ammonium alginate, calcium alginate, agar, propylene glycoalginate, carrageen, furcellerane, locust bean gum, CMC's, guar gum, and/or gellangum.

The starch or modified starch can be obtained from any suitable source such as maize, wheat, rice, tapioca, and/or soy.

According to the present invention, the modified starch of the heat-binder comprises a hydroxypropyl starch phosphate.

Other suitable heat-binders are, amongst others, dextrin, acid-treated starch, alkali-treated starch, bleaches starch, oxidised starch, mono-starch phosphate, di-starch glycerol, di-starch phosphate, phosphonated di-starch phosphate, acetylated di-starch phosphate, getflour acetate, acetylated di-starch adipate, acetylated di-starch glycerol, hydroxypropyl starch, hydroxypropyl di-starch glycerol, hydroxypropyl di-starch phosphate, starch sodium octenyl succinate.

Especially preferred characteristics of the present chips or French fries are obtained when the heat-binder has a viscosity, at 95° C., of between 600 and 1000 BU (Brabender viscosity units).

The viscosity of the heat-binder is determined by heating a suspension of the heat-binder (500 mg in a concentration of 32 mg/g dry matter in water of 5-7° dH) from 50° C. to 95° C. (rate 1.5° C./min) and maintaining the suspension at this temperature for 30 minutes. The apparatus used for the measurement of the viscosity is the Brabender E-type with a head of 350 cmg and n is 75 per minute.

Further, preferred characteristics of the present chips or French fries are obtained when the cold-binder has a viscosity of between 1500 to 5000 mPa·s.

The viscosity of the cold-binder is measured by adding 10 grams of the cold-binder to 12 ml ethanol (v/v) and, subsequently, 190 ml distilled water. This is achieved by moistening with ethanol and, subsequently, by adding of water within 1 minute while continuously stirring using a glass rod. The viscosity is then determined by conditioning at 20° C. for 30 minutes and, subsequently, feeding into a Brookfield LVF; spindle is 2, n is 6, and reading out after 5 revolutions.

The above indicated heat- and cold-binders are preferably combined, especially when only a vegetable source with no fruit source is used.

According to another preferred aspect of the present method, the present chips or French fries are processed for consumption by frying, steaming, microwave heating, deep frying or baking after step (iii), preferably deep frying.

According to the present invention, for deep frying, an oil is used comprising less than 25% saturated fat and/or less than 1% free fatty acids.

Preferably, the mixture according to the present invention further comprises meat, fish, flavouring agents, antioxidant, bouillon, browning means and/or conservatives.

The chips or French fries according to the present invention are preferably, after step (ii), coated with, for example, bread crumbs.

According to a particularly preferred aspect of the present invention, the present mixture further comprises prebiotics.

A prebiotic is defined as a, for a host, such as a human, “non-digestible” food ingredient promoting the growth of one or more specific bacterial species, such as bifidobacteria or lactobacilli, in the colon. Suitable examples of prebiotics are fructans such as inuline and FOS; GOS (Galacto-oligosaccharides); and Xylo oligosaccharides and other oligosaccharides.

Considering the beneficial effects, especially with respect to obesitas and vegetable intake, of the chips or French fries provided by the present method, the present invention also relates to chips or French fries obtainable by the present methods.

The present invention will be further detailed below in the examples of preferred embodiments. However, these examples are only provided to further illustrate the invention as outlined above and, as such, should not be regarded as limiting for the scope of the appended claims.

### EXAMPLES

### Example I

### Formulation 1 for Vegetable Chips or French Fries

| | | Percentage |
|---|---|---|
| Ingredient | | (w/w) |
| 1 | Green peas | 37.3 |
| 2 | Vegetable fluid | 20.7 |
| | (water, sugar, salt, natural flavouring agents) | |
| 3 | Maize (precooked) | 12.4 |
| 4 | Carrots (precooked) | 12.4 |
| 5 | Soy protein | 2.9 |
| 6 | Vegetable oil | 1.7 |
| 7 | Egg protein in powder form | 1.2 |
| 8 | Whey powder concentrate | 0.6 |
| 9 | Vegetarian garden herbs bouillon | 0.4 |
| 10 | Modified starch (heat-binder) | 6.0 |
| 11 | Pregeletinized modified starch (cold-binder) | 4.3 |

The above ingredients were used in a method for the preparation of vegetable chips or French fries in the amounts indicated. The method comprised:
a) Adding into a blender ingredients 1 to 9;
b) Blending the ingredients in the blender until an uniform smooth mass is obtained;
c) Adding, by gently mixing (not blending), ingredient 10 until an uniform smooth mass is obtained;
d) Adding, by gently mixing (not blending), ingredient 11 until an uniform smooth mass is obtained;
e) Moulding the mass obtained into chips, for example, by using a form extruder or a Tromp Unimac dosing & forming apparatus;
f) Cutting the moulded mass to a suitable length;
g) Freezing the product of (f);
h) Deep frying of the product of (g) at 180° C. for about 3 minutes;

### Example II

### Formulation 2 for Vegetable Chips or French Fries

| | | Percentage |
|---|---|---|
| Ingredient | | (w/w) |
| 1 | Green peas | 37.3 |
| 2 | Vegetable fluid | 20.7 |
| | (water, sugar, salt, natural flavouring agents) | |
| 3 | Maize (precooked) | 12.4 |
| 4 | Carrots (precooked) | 12.4 |
| 5 | Inuline | 3.5 |
| 6 | Soy protein | 1.8 |
| 7 | Vegetable oil | 1.6 |
| 8 | Egg protein in powder form | 1.1 |
| 9 | Whey powder concentrate | 0.6 |
| 10 | Vegetarian garden herbs bouillon | 0.4 |
| 11 | Modified starch (heat-binder) | 4.9 |
| 12 | Pregeletinized modified starch (cold-binder) | 3.2 |

The above ingredients were used in a method for the preparation of vegetable chips or French fries in the amounts indicated. The method comprised:
a) Adding into a blender ingredients 1 to 10;
b) Blending the ingredients in the blender until an uniform smooth mass is obtained;
c) Adding, by gently mixing (not blending), ingredient 10 until an uniform smooth mass is obtained;
d) Adding, by gently mixing (not blending), ingredient 11 until an uniform smooth mass is obtained;
e) Moulding the mass obtained into chips, for example, by using a form extruder or a Tromp Unimac dosing & forming apparatus;
f) Cutting the moulded mass to a suitable length;
g) Freezing the product of (f);
h) Deep frying of the product of (g) at 180° C. for about 3 minutes;

1-19. (canceled)

20. A method for the preparation of vegetable chips or French fries, comprising:
i) preparing a mixture comprising between 20% to 90% (w/w) of a vegetable source and/or fruit source, a protein source, between 0% to 30% (w/w) water and a thickening agent;
ii) moulding the mixture prepared into chips or French fries;
wherein none of said vegetable, fruit and protein sources comprise potato.

21. The method according to claim 20, wherein the vegetable course is chosen from the group consisting of maize, carrot, pea, broccoli, cauliflower, bean, green bean, haricot bean, leek, onion, beet, rutabaga, and combinations thereof.

22. The method according to claim 20, comprising step (iii) comprising freezing said chips or French fries obtained.

23. The method according to claim 20, wherein said vegetable and/or fruit source is preheated.

24. The method according to claim 20, wherein said vegetable source comprises 50% to 60% (w/w) of said mixture.

25. The method according to claim 20, wherein said protein source comprises 2% to 30% (w/w) of said mixture.

26. The method according to claim 20, wherein said protein source is chosen from the group consisting of meat protein, blood protein, egg protein, whole egg, bean, and combinations thereof.

27. The method according to claim 20, wherein the thickening agent comprises a heat-binder and/or cold-binder.

28. The method according to claim 27, wherein said heat-binder and/or cold-binder comprises modified starch or gum.

29. The method according to claim 28, wherein said modified starch of the heat-binder comprises hydroxypropyl starch phosphate.

30. The method according to claim 28, wherein said modified starch of the cold-binder comprises pregelatinized starch phosphate.

31. The method according to claim 27, wherein said heat binder has a viscosity of between 660 to 1000 BU at 95° C. after 30 minutes.

32. The method according to claim 27, wherein said cold-binder has a viscosity of between 1500 and 5000 mPa·s.

33. The method according to claim 22, wherein said chips or French fries are processed for consumption by flying, steaming, microwave heating, deep flying or baking after step (iii).

34. The method according to claim 33, wherein said chips or French fries are processed for consumption by deep frying.

35. The method according to claim 34, wherein for said deep frying an oil is used comprising less than 25% saturated fat and/or less than 1% free fatty acids.

36. The method according to claim 20, wherein said mixture further comprises meat, fish, flavoring agents, antioxidant, bouillon, browning means, and/or conservatives.

37. The method according to claim 20, wherein, after step (ii), said chips or French fries are coated.

38. The method according to claim 20, wherein said mixture further comprises prebiotics.
